(19) United States
(12) Patent Application Publication
(10) Pub. No.: US 2017/0200187 A1
(43) Pub. Date: Jul. 13, 2017

(54) Method for Determining Effectiveness in Marketing and a Device Thereof

(71) Applicant: Wipro Limited, Bangalore (IN)

(72) Inventors: Venkata Subramanian JAYARAMAN, Chennal (IN); Sumithra SUNDARESAN, Chennal (IN)

(73) Assignee: Wipro Limited

(21) Appl. No.: 15/052,020

(22) Filed: Feb. 24, 2016

(30) Foreign Application Priority Data
Jan. 12, 2016 (IN) 201641001067

(51) Int. Cl. G06Q 30/02

(52) U.S. Cl. CPC G06Q 30/0242; G06Q 30/0247

(57) ABSTRACT

The present disclosure relates to a method for determining effectiveness in marketing. A evaluation device receives marketing data from one or more data sources. The received marketing data is used to determine one or more scores corresponding to each of one or more end users. The one or more scores maybe a first score, a second score and a third score. The evaluation device uses the determined each of the one or more scores to determine an opportunity value that indicates the opportunity available to achieve a predefined target with respect to each of the one or more end users. The evaluation device also determines a revenue generation value that indicates revenue being generated with respect to each of the one or more end users. The opportunity value and revenue generation value are correlated to obtain an effectiveness result indicating the effectiveness in the marketing.

### TECHNICAL FIELD

The present subject matter is related, in general to data analytics, and more particularly, but not exclusively to a method and a device for determining effectiveness in marketing.

### BACKGROUND

Data Analytics has taken over the world for providing details regarding each and every activity that happens in any field. One of the major uses of data analytics is the predictions that can be made based on the analysis and co-relate the results obtained to the overall success that could be achieved. Currently, in spite of having abundant information, the information is not being analyzed to its complete potential.

As an example, if we consider data analytics in the field of marketing of goods and services, there is abundant data available such as time spent by a customer in a store, the items that the customer has purchased, the kind of products that the customer has a look into while purchasing, the brand that the customer is buying, the pattern of the purchases made by the customer etc. The existing techniques analyze these data to provide requested information to a third party, to obtain information before promotion of certain goods and after promotion of the certain goods to check the increase in sales, to obtain values related to customer experience, to obtain values related to sales increase etc. But this kind of data analysis provides a very basic result i.e. the information obtained from the analysis is not sufficient for measuring effectiveness of the marketing of the goods and services. Also, the basic level of analysis does not provide solution to problems such as, how potential customers can be identified and targeted, how to identify the advantageous factor of a certain brand over other brands, how a retailer can know the item or the type of goods to be promoted etc. Effective marketing cannot be performed if the analysis does not provide the potential information required for obtaining more visibility of the issues present in the marketing and sales. Also, analysis may be mainly concentrated for understanding the sales generated based on the promotion of goods and services. Analysis can be performed at customer level i.e. analysis with respect to each customer. This kind of analysis provides more details which are overlooked during the basic analysis.

Therefore there is a need for a method and device which provides more visibility of the issues in marketing and evaluates the effectiveness in marketing at end user level based on potential analysis of the data.

### SUMMARY

One or more shortcomings of the prior art are overcome and additional advantages are provided through the present disclosure. Additional features and advantages are realized through the techniques of the present disclosure. Other embodiments and aspects of the disclosure are described in detail herein and are considered a part of the claimed disclosure.

Disclosed herein are method and device for determining effectiveness of marketing. The evaluation device receives marketing data from one or more data sources. Based on the received marketing data, an opportunity value and a revenue generation value are calculated for each end user. The opportunity value indicates opportunity available for achieving a predefined target corresponding to each end user. The revenue generation value indicates revenue being generated, corresponding to each end user, based on the marketing. Finally, the evaluation device determines effectiveness of the marketing for each end user, by correlating the respective opportunity value and the revenue generation value. The effectiveness result indicates the success or failure in achieving a predefined target in marketing.

Accordingly, the present disclosure relates to a method for determining effectiveness in marketing. The method comprises receiving, by an evaluation device, marketing data from one or more data sources. Thereafter, the evaluation device determines one or more scores based on the marketing data, wherein the one or more scores comprises a first score related to one or more end users, a second score related to entities and a third score related to factors associated with the one or more end users and the entities. Further, the evaluation device determines an opportunity value for each of the one or more end users based on each of the one or more scores. The opportunity value indicates opportunity available for achieving a predefined target corresponding to each of the one or more end users. Upon determining the opportunity value, the evaluation device, determines a revenue generation value for each of the one or more end users based on the determined each of the one or more scores, wherein the revenue generation value indicates revenue being generated, corresponding to each of the one or more end users, based on the marketing. Finally, the evaluation device determines an effectiveness result based on the opportunity value and the revenue generation value, wherein the effectiveness result indicates the effectiveness in the marketing.

Further, the present disclosure relates to an evaluation device for determining effectiveness in marketing. The evaluation device comprises a processor and a memory communicatively coupled to the processor, wherein the memory stores the processor-executable instructions; which, on execution, causes the processor to receive marketing data from one or more data sources. Upon receiving the marketing data, the processor determines one or more scores corresponding to each of one or more end users based on the marketing data. The one or more scores comprise a first score related to one or more end users, a second score related to entities and a third score related to factors associated with the one or more end users and the entities. Further, the processor determines an opportunity value for each of the one or more end users based on the determined each of the one or more scores. The opportunity value indicates opportunity available for achieving a predefined target corresponding to each of the one or more end users. Upon determining the opportunity value, the processor determines a revenue generation value for each of the one or more end users based on the determined each of the one or more scores, wherein the revenue generation value indicates revenue being generated, corresponding to each of the one or more end users, based on the marketing. Finally, the processor determines an effectiveness result based on the opportunity value and the revenue generation value, wherein the effectiveness result indicates the effectiveness in the marketing.

Further, the present disclosure comprises a non-transitory computer readable medium including instructions stored thereon that when processed by at least one processor causes an evaluation device to perform operations comprising receiving marketing data from one or more data sources. The instructions further cause the processor to determine one or more scores corresponding to each of one or more end users based on the marketing data. The one or more scores comprise a first score related to one or more end users, a second score related to entities and a third score related to factors associated with the one or more end users and the entities. Thereafter, the instructions cause the processor to determine an opportunity value for each of the one or more end users based on the determined each of the one or more scores. The opportunity value indicates opportunity available for achieving a predefined target corresponding to each of the one or more end users. Upon determining the opportunity value, the instructions causes the processor to determine a revenue generation value for each of the one or more end users based on the determined each of the one or more scores, wherein the revenue generation value indicates revenue being generated, corresponding to each of the one or more end users, based on the marketing. Finally, the instructions causes the processor to determine an effectiveness result based on the opportunity value and the revenue generation value, wherein the effectiveness result indicates the effectiveness in the marketing.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE ACCOMPANYING DIAGRAMS

The accompanying drawings, which are incorporated in and constitute a part of this disclosure, illustrate exemplary embodiments and, together with the description, serve to explain the disclosed principles. In the figures, the left-most digit(s) of a reference number identifies the figure in which the reference number first appears. The same numbers are used throughout the figures to reference like features and components. Some embodiments of system and/or methods in accordance with embodiments of the present subject matter are now described, by way of example only, and with reference to the accompanying figures, in which:

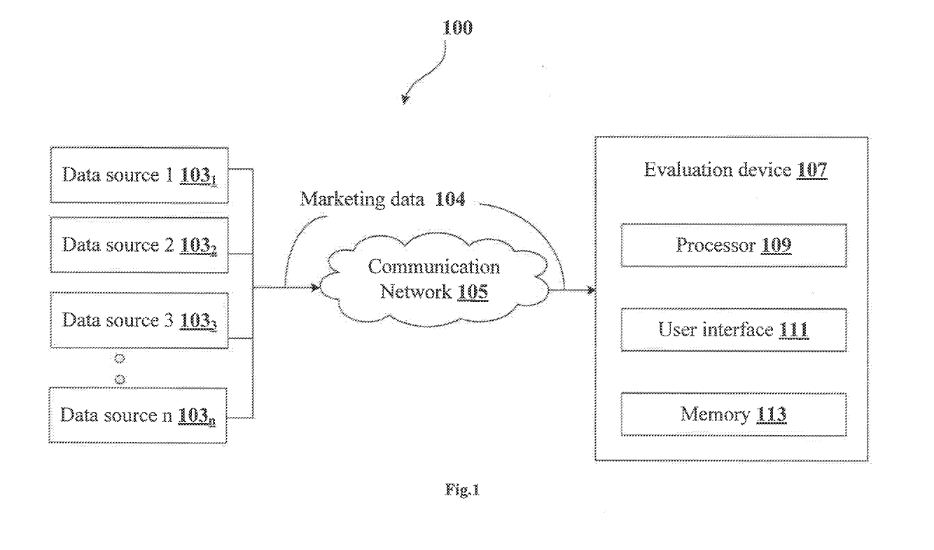

FIG. 1 shows an exemplary architecture for determining effectiveness in marketing in accordance with some embodiments of the present disclosure;

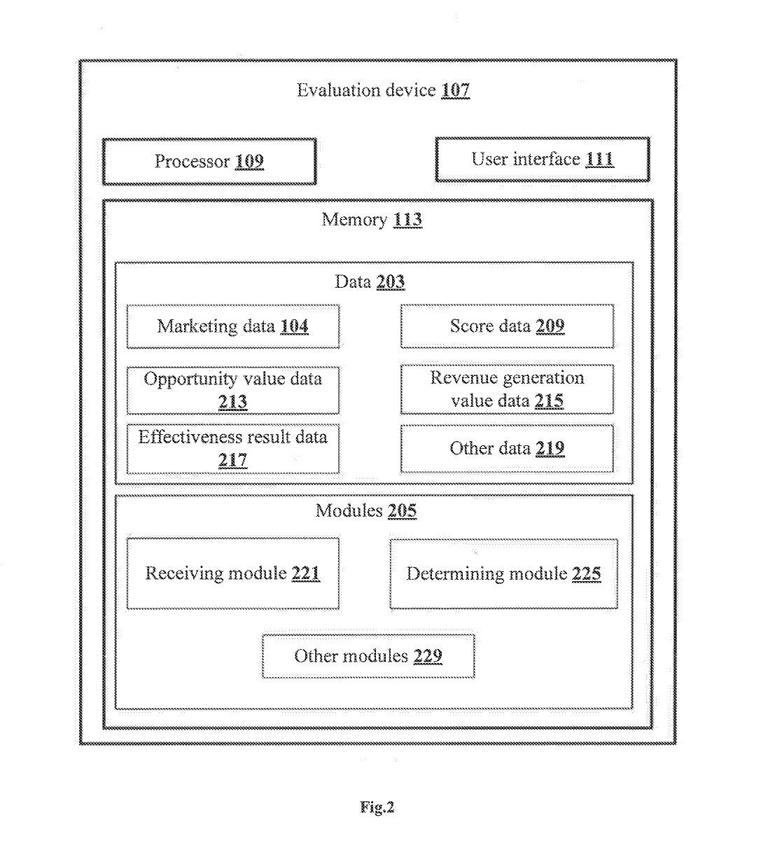

FIG. 2 shows a detailed block diagram of an evaluation device for determining effectiveness in marketing in accordance with some embodiments of the present disclosure;

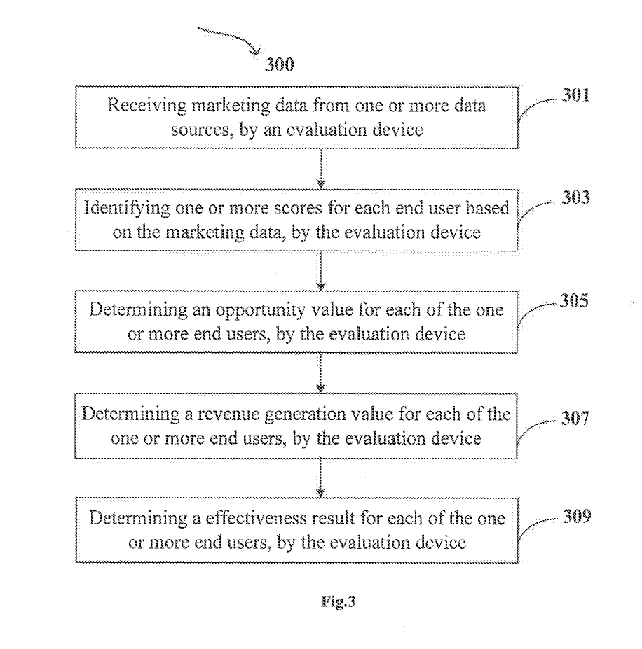

FIG. 3 illustrates a flowchart for determining effectiveness in marketing in accordance with some embodiments of the present disclosure; and

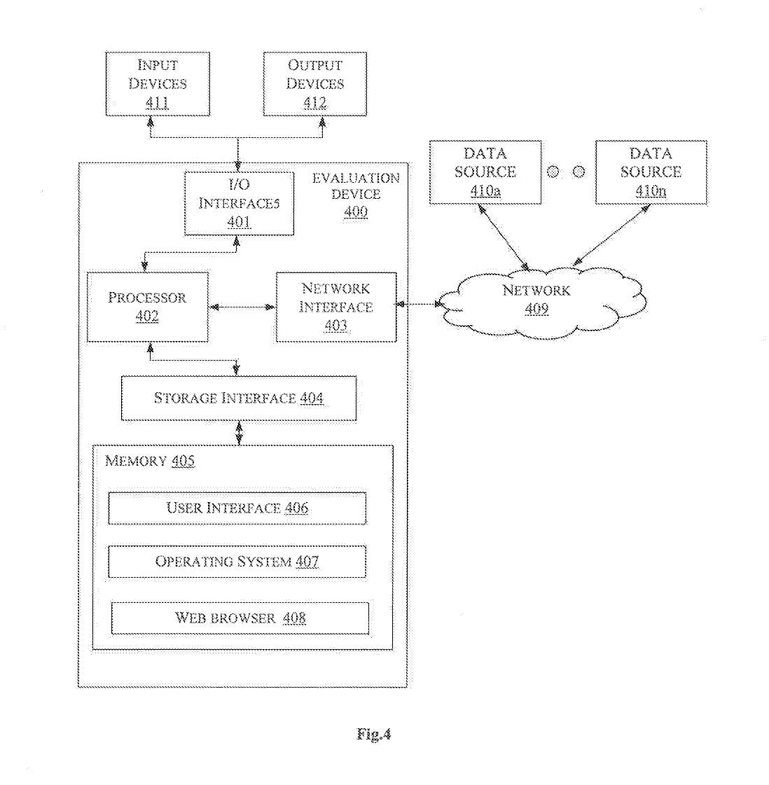

FIG. 4 is a block diagram of an exemplary computer system for implementing embodiments consistent with the present disclosure.

It should be appreciated by those skilled in the art that any block diagrams herein represent conceptual views of illustrative systems embodying the principles of the present subject matter. Similarly, it will be appreciated that any flow charts, flow diagrams, state transition diagrams, pseudo code, and the like represent various processes which may be substantially represented in computer readable medium and executed by a computer or processor, whether or not such computer or processor is explicitly shown.

### DETAILED DESCRIPTION

In the present document, the word “exemplary” is used herein to mean “serving as an example, instance, or illustration.” Any embodiment or implementation of the present subject matter described herein as “exemplary” is not necessarily to be construed as preferred or advantageous over other embodiments.

While the disclosure is susceptible to various modifications and alternative forms, specific embodiment thereof has been shown by way of example in the drawings and will be described in detail below. It should be understood, however that it is not intended to limit the disclosure to the particular forms disclosed, but on the contrary, the disclosure is to cover all modifications, equivalents, and alternative falling within the scope of the disclosure.

The terms “comprises”, “comprising”, or any other variations thereof, are intended to cover a non-exclusive inclusion, such that a setup, device or method that comprises a list of components or steps does not include only those components or steps but may include other components or steps not expressly listed or inherent to such setup or device or method. In other words, one or more elements in a system or apparatus proceeded by “comprises . . . a” does not, without more constraints, preclude the existence of other elements or additional elements in the system or method.

The present disclosure relates to a method and device for determining effectiveness in marketing. An evaluation device receives marketing data from one or more data sources. The marketing data may depend on the scenario where the evaluation device is used or implemented. As an example, consider that the evaluation device is used for determining effectiveness in marketing of goods and services. In this scenario, the marketing data refers to data related to the one or more customers such as customer's first visit to a store, customer's last visit to a store, items purchased by the customer, mode of payment the customer used etc., data related to items such as items that newly entered in a market, items that are frequently sold in the market, frequency of an item sold in the market etc. and data related to the factors associated with one or more customers and the items, such as, type of coupons used by the customer to make a purchase, age of the customer, location of the customer etc.

The received marketing data is used to determine one or more scores related to each of one or more end users. The one or more scores may be a first score, a second score and a third score. The first score is related to the one or more end users, the second score is related to entities, and the third score is related to factors associated with the one or more end users and the entities. Considering the aforementioned example of marketing of goods and services, the first score may be referred to a customer score, the second score may be referred to an item score and the third score may be referred to a heterogeneity score. The customer score is related to the one or more customers of the goods and service, the item score is related to the items for marketing and the heterogeneity score is related to the factors associated with the one or more customers and the items. The evaluation device uses each of the one or more scores to determine an opportunity value. The opportunity value indicates opportunity available to achieve a predefined target with respect to each of the one or more end users. The evaluation device also determines a revenue generation value that indicates revenue being generated with respect to each of the one or more end users. The opportunity value and revenue generation value are correlated to obtain an effectiveness result indicating the effectiveness in the marketing i.e. whether the marketing was successful or not.

In the following detailed description of the embodiments of the disclosure, reference is made to the accompanying drawings that form a part hereof, and in which are shown by way of illustration specific embodiments in which the disclosure may be practiced. These embodiments are described in sufficient detail to enable those skilled in the art to practice the disclosure, and it is to be understood that other embodiments may be utilized and that changes may be made without departing from the scope of the present disclosure. The following description is, therefore, not to be taken in a limiting sense.

FIG. 1 shows an exemplary architecture for determining effectiveness in marketing in accordance with some embodiments of the present disclosure.

The architecture 100 comprises one or more data sources, data source 1 103₁ to data source n 103ₙ (collectively referred to as one or more data sources 103), a communication network 105 and an evaluation device 107. As an example, the one or more data sources 103 may include, but not limited to, entity management systems like item management system, end user database system like customer data base system, end user log such as visitors log, time in and time out logs etc. and video recording device such as camera. The one or more data sources 103 are configured to collect marketing data 104 and provide the collected marketing data 104 to the evaluation device 107 through the communication network 105. The communication network 105 maybe at least one of wired communication network and wireless communication network.

The present disclosure further would be explained considering a scenario where the evaluation device 107 is used for determining effectiveness in marketing of goods and services. In this scenario, the marketing data 104 refers to data related to the one or more customers such as customer's first visit to a store, customer's last visit to a store, items purchased by the customer, mode of payment the customer used etc., data related to items such as items that newly entered the market, items that are frequently sold in the market, frequency of an item sold in the market etc., data related to the factors associated with one or more customers and the items, such as, type of coupons used by the customer to make a purchase, age of the customer, location of the customer etc.

The evaluation device 107 comprises a processor 109, user interface 111 and memory 113. The user interface 111 is configured to receive the marketing data 104 from the one or more data sources 103. The received marketing data 104 is stored in the memory 113. The processor 109 determines one or more scores based on the marketing data 104, with respect to each of the one or more end users. In an embodiment, the one or more scores may be a first score, a second score and a third score. The first score is related to the one or more end users, the second score is related to entities and the third score is related to factors associated with the one or more end users and the entities. Considering the above mentioned example of marketing of goods and services, the one or more scores are determined with respect to each of the one or more customers, by the processor 109. The first score may be referred as a customer score, the second score may be referred as an item score and the third score may be referred as a heterogeneity score. The customer score is related to the one or more customers of the goods and services, the item score is related to the items in the marketing and the heterogeneity score is related to the factors associated with the one or more customers and the items.

The first score is calculated based on one or more predefined first parameters, associated with the one or more customers. The one or more predefined first parameters may be referred to as customer parameters. The customer parameters may include, but not limited to, customer visit to a store and time spent in the store, frequency of customer's visit to the store, total purchase made by the customer, trend of purchase of the customer and satisfaction level of a customer. Each of the one or more predefined first parameters is classified into a low category, a medium category and a high category. Each of the low category, the medium category and the high category is associated with a predefined weightage and a predefined impact value. As an example, the low category may have the predefined weightage of “5” and the predefined impact value “1”. Thereafter, each of the low category, the medium category and the high category is assigned with a predefined rating value based on the predefined weightage and the predefined impact value assigned to each of the low category, the medium category and the high category. In an embodiment, the predefined rating value is calculated using the below mentioned equation (Equation 1).

Predefined rating value=Predefined weightage*Predefined impact value (Equation 1)

As an example, if the predefined weightage of the low category is 5 and the predefined impact value of the low category is 1, then the predefined rating value of the low category is 5.

Similarly, if the predefined weightage of the medium category is 10 and the predefined impact value of the medium category is 2, then the predefined rating value of the medium category is 20.

Similarly, if the predefined weightage of the high category is 15 and the predefined impact value of the high category is 3, then the predefined rating value of the high category is 45.

The first score is calculated based on the predefined rating value associated for each of the customer parameters using a first predefined technique as shown in the below mentioned equation (Equation 2).

Customer score=(Sum of((Customer visit to a store and time spent in the store)+(Frequency of customer's visit to a store)+(Total purchases made by the customer)+(Trend of purchase)+(satisfaction))/Count of non-zero((Customer visit to a store and time spent in the store)+(Frequency of customer's visit to a store)+(Total purchases made by the customer)+(Trend of purchase)+(satisfaction)) (Equation 2)

The second score is calculated based on one or more predefined second parameters, associated with the entities. The one or more predefined second parameters are referred to as item parameters. The item parameters may include, but not limited to, when the item entered the market, the item sold in the market, frequency of the item sold on a monthly basis, frequency of the item sold in the area and whether the item is sold with or without promotions. Each of the one or more predefined second parameters is classified into the low category, the medium category and the high category. Each of the low category, the medium category and the high category is associated with the predefined weightage and the predefined impact value. Thereafter, each of the low category, the medium category and the high category is assigned with the predefined rating value based on the predefined weightage and the predefined impact value assigned to each of the low category, the medium category and the high category. The second score is calculated based on the predefined rating value associated with each of the item parameters using a second predefined technique as shown in the below mentioned equation (Equation 3).

Item score=(Sum of((When the item entered the market)+(The item sold in the market)+(Frequency of the item sold on a monthly basis)+(Frequency of the item sold in areas by payment)+(Items sold without promotions))/Count of non-zero((When the item entered the market)+(The item sold in the market)+(Frequency of the item sold on a monthly basis)+(Frequency of the item sold in areas by payment)+(Items sold without promotions)) (Equation 3)

The third score is calculated based on one or more predefined third parameters, associated with factors related to the one or more end users and the entities. The one or more predefined third parameters are referred to as heterogeneity parameters. The heterogeneity parameters may include, but not limited to, average age of the one or more customers purchasing the item, type of purchase, value of purchase, location of the customer who purchased the item by payment and purchase made using the promo codes or coupons. Each of the one or more predefined third parameters is classified into the low category, the medium category and the high category. Each of the low category, the medium category and the high category is associated with the predefined weightage and the predefined impact value. Thereafter, each of the low category, the medium category and the high category is assigned with the predefined rating value based on the predefined weightage and the predefined impact value assigned to each of the low category, the medium category and the high category. The third score is calculated based on the predefined rating value associated for each of the heterogeneity parameters using a third predefined technique as shown in the below mentioned equation (Equation 4).

Heterogeneity score=(Sum of((Average age of the one or more customers purchasing the item)+(Type of purchase)+(Value of purchase)+(Location of the customer who purchased the item by payment)+(Purchase made using the promo codes or coupons))/Count of non-zero((Average age of the one or more customers purchasing the item)+(Type of purchase)+(Value of purchase)+(Location of the customer who purchased the item by payment)+(Purchase made using the promo codes or coupons)) (Equation 4)

The processor 109 uses each of the one or more scores to determine an opportunity value using a fourth predefined technique as shown in below mentioned equation (Equation 5).

Opportunity value=(Item score*Heterogeneity score)/Customer score (Equation 5)

The opportunity value indicates the opportunity available to achieve a predefined target with respect to each of the one or more end users i.e. the opportunity value may determine how much revenue can be generated from the one or more customers if more promotions are provided to the one or more customers.

The processor 109 also uses the one or more scores to determine a revenue generation value using the fifth predefined technique as shown in below mentioned equation (Equation 6).

Revenue generation value=(Item score*Customer score)/Base value defined in the currency (Equation 6)

In the above mentioned equation (Equation 6), the base value is a predefined value to be achieved for each of the one or more customers, set by a marketing team and may be represented in any currency value.

The revenue generation value indicates revenue being generated with respect to each of the one or more end users. As an example, the revenue generation value may determine whether promotion of a specified item in the market has reached the pre-set benchmark or not.

The opportunity value and revenue generation value are correlated to obtain an effectiveness result indicating the effectiveness in the marketing using a sixth predefined technique as shown in below mentioned equation (Equation 7).

Effectiveness Result=1−2×(Revenue Generation value)/1−Opportunity value (Equation 7)

The effectiveness result may determine the success or failure of a promotion/marketing for items in the market.

FIG. 2 shows a detailed block diagram of an evaluation device for determining effectiveness in marketing in accordance with some embodiments of the present disclosure.

In one implementation, a user interface 111 configured in the evaluation device 107, receives marketing data 104 from the one or more data sources 103. As an example, the marketing data 104 is stored in a memory 113 configured in the evaluation device 107. In one embodiment, data 203 includes marketing data 104, score data 209, opportunity value data 213, revenue generation value data 215, effectiveness result data 217 and other data 219. In the illustrated FIG. 2, modules 205 stored in the memory 113 are described herein in detail.

In one embodiment, the data may be stored in the memory 113 in the form of various data structures. Additionally, the aforementioned data can be organized using data models, such as relational or hierarchical data models. The other data 219 may store data, including temporary data and temporary files, generated by modules 205 for performing the various functions of the evaluation device 107.

In one embodiment, the marketing data 104 is received from the one or more data sources 103. As an example, the one or more data sources 103 may include, but not limited to, entity management systems like item management system, end user database system like customer data base system, end user log such as visitors log, time in and time out logs etc. The marketing data 104 may depend on the scenario where the evaluation device 107 is utilized. As an example, consider the evaluation device 107 is used for determining effectiveness in marketing of goods and services. In this scenario, the marketing data 104 refers to data related to the one or more customers such as customer's first visit to a store, the customer's last visit to a store, items purchased by the customer, mode of payment the customer used etc., data related to items such as items that newly entered in a market, items that are frequently sold in the market, frequency of an item sold in the market etc., data related to the factors associated with one or more customers and the items, such as, type of coupons used by the customer to make a purchase, age of the customer, location of the customer etc.

In one embodiment, the score data 209 comprises one or more scores determined by the processor 109, with respect to each of the one or more end users. The one or more scores maybe, a first score related to the one or more end users, a second score related to the entities and a third score related to the factors associated with the one or more end users and the entities. Considering the aforementioned example of marketing of goods and services, the first score may be referred as a customer score, the second score may be referred as an item score and the third score may be referred as a heterogeneity score. The customer score is related to the one or more customers of the goods and service, the item score is related to the items for marketing and the heterogeneity score is related to the factors associated with the one or more customers and the items.

The customer score for each of the one or more customers may be calculated using the first predefined technique as shown in Equation 2. The item score for each of the one or more customers may be calculated using the second predefined technique as shown in Equation 3. The heterogeneity score for each of the one or more customers may be calculated using the third predefined technique as shown in Equation 4.

In one embodiment, the opportunity value data 213 comprises an opportunity value determined with respect to each of the one or more end users. The opportunity value data 213 indicates opportunity available to achieve a predefined target with respect to each of the one or more end users. The opportunity value is determined using the one or more scores determined with respect to each of the one or more end users. The opportunity value may determine how much revenue can be generated from the one or more customers if more promotions are provided to the one or more customers. A fourth predefined technique as shown in Equation 5 may be used to calculate the opportunity value for each of the one or more customers.

In an embodiment, revenue generation value data 215 comprises a revenue generation value determined with respect to each of the one or more end users. The revenue generation value data 215 indicates revenue being generated with respect to each of the one or more end users. The revenue generation value is determined using the one or more scores determined with respect to each of the one or more end users. The fifth predefined technique as shown in Equation 6 may be used to calculate the revenue generation value for each of the one or more customers.

In an embodiment, effectiveness result data 217 comprises, an effectiveness result indicating effectiveness in the marketing, with respect to each of the one or more end users. The opportunity value and the revenue generation value are correlated using Equation 7 to obtain the effectiveness result indicating the effectiveness in marketing. The effectiveness result may determine the success or failure of a promotion/marketing for items in the market.

In an embodiment, the data stored in the memory 113 is processed by the modules 205 of the evaluation device 107. The modules 205 may be stored within the memory 113 as shown in the FIG. 2. In an example, the modules 205, communicatively coupled to the processor 109, may also be outside the memory 113.

In an embodiment, the modules 205 may include, for example, a receiving module 221, a determining module 225 and other modules 229. The other modules 229 may be used to perform various miscellaneous functionalities of the evaluation device 107. It will be appreciated that such aforementioned modules 205 may be represented as a single module or a combination of different modules.

In one embodiment, the receiving module 221 receives the marketing data 104 from the one or more data sources 103. As an example, the one or more data sources 103 may include, but not limited to, entity management systems like item management system, end user database system like customer data base system, end user log such as visitors log, time in and time out logs etc. and video recording device such as camera. The marketing data 104 received by the receiving module 221 may be, data related to the one or more customers such as data related to the customer's first visit to a store, data related to the customer's last visit to a store, items purchased by the customer, mode of payment the customer used etc., data related to items such as items that newly entered in a market, items that are frequently sold in the market, frequency of an item sold in the market etc., data related to the factors associated with the one or more customers and the items, such as, type of coupons used by the customer to make a purchase, age of the customer, location of the customer etc.

In one embodiment, the determining module 225 determines one or more scores with respect to each of the one or more end users. The one or more scores may be a first score, a second score and a third score. The first score is calculated based on one or more predefined first parameters, associated with the one or more end users. Each of the one or more predefined first parameters is classified into a low category, a medium category and a high category. Each of the low category, the medium category and the high category is associated with a predefined weightage and a predefined impact value. As an example, the low category may have the predefined weightage of 5 and the predefined impact value 1. Thereafter, each of the low category, the medium category and the high category is assigned with a predefined rating value based on the predefined weightage and the predefined impact value assigned to each of the low category, the medium category and the high category. The first score is calculated based on the predefined rating value using the first predefined technique.

The second score is calculated based on one or more predefined second parameters, associated with the entities. Each of the one or more predefined second parameters is classified into the low category, the medium category and the high category. Each of the low category, the medium category and the high category is associated with the predefined weightage and the predefined impact value. Thereafter, each of the low category, the medium category and the high category is assigned with the predefined rating value based on the predefined weightage and the predefined impact value assigned to each of the low category, the medium category and the high category. The second score is calculated based on the predefined rating value using the second predefined technique.

The third score is calculated based on one or more predefined third parameters, associated with the factors related to the one or more end users and the entities. Each of the one or more predefined third parameters is classified into the low category, the medium category and the high category. Each of the low category, the medium category and the high category is associated with the predefined weightage and the predefined impact value. Thereafter, each of the low category, the medium category and the high category is assigned with the predefined rating value based on the predefined weightage and the predefined impact value assigned to each of the low category, the medium category and the high category. The third score is calculated based on the predefined rating value using a third predefined technique.

Considering the aforementioned example of marketing of goods and services, the first score may be referred as customer score, the second score may be referred as an item score and a third score may be referred as heterogeneity score. The customer score is related to the one or more customers of the goods and services, the item score is related to the items for marketing and the heterogeneity score is related to factors associated with the one or more customers and the items. The customer score is calculated based on one or more predefined customer parameters, associated with the one or more customers. The one or more predefined customer parameters may include, but not limited to, customer visit to a store and time spent in the store, frequency of customer's visit to the store, total purchases made by the customer, trend of purchase of the customer and satisfaction level of a customer. Each of the one or more predefined customer parameters is classified into the low category, the medium category or the high category as shown in the below Table 1.

TABLE 1

| Customer parameters | Content of the customer parameters | Category |
|---|---|---|
| Customer visit to | Comes and leaves immediately | Low |
| a store and time | Comes, scans and leaves in half an | Medium |
| | hour | |
| spent in the store | Comes, scans, analyses and leaves | High |
| | after 1 hour | |
| Frequency of | Visits store once a month | Low |
| customer's | Visits store one a week to once a | Medium |
| | month | |
| visit to a store | Visits often within a week | High |
| | After first visit never visited | Not |
| | | applicable |
| Total purchases | More than 100 | High |
| made by the | Between 50 to 100 | Medium |
| customer | Less than 50 | Low |
| Trend of purchase | All varieties of products | High |
| | Limited varieties of products | Medium |
| | Only 1 variety | Low |
| Satisfaction level | Not happy | Low |
| | Happy | Medium |
| | Very happy | High |

Each of the low category, the medium category and the high category is associated with the predefined weightage and the predefined impact value as shown in the below Table 2.

TABLE 2

| | Predefined | Predefined | Predefined |
|---|---|---|---|
| Categories | Weightage | impact value | rating value |
| Low | 5 | 1 | 5 |
| Medium | 10 | 2 | 20 |
| High | 15 | 3 | 45 |

According to the above Table 2, the predefined weightage and the predefined impact value associated with the low category are 5 and 1 respectively. The predefined weightage and the predefined impact value associated with the medium category are 10 and 2 respectively. The predefined weightage and the predefined impact value associated with the High category is 15 and 3 respectively.

In an embodiment, the predefined rating value is calculated using the Equation 1.

As an example, the predefined rating value of low category is 5, the predefined rating value of the medium category is 20 and the predefined rating value of the high category is 45.

As an example, consider the customer parameter “customer visit to a store and time spent in the store” from Table 1.

The customer parameter “customer comes and leaves immediately” belongs to the low category. Therefore, the predefined rating value assigned is 5.

The customer parameter “customer comes, scans and leaves in half an hour” belongs to the medium category. Therefore, the predefined rating value assigned is 20.

The customer parameter “customer comes, scans, analyses and leaves after 1 hour” belong to the high category. Therefore, the predefined rating value assigned is 45.

As an example, the Table 3 below shows the predefined rating value assigned to a Customer “A”.

TABLE 3

| | | Predefined |
|---|---|---|
| Customer parameters | Categories | rating value |
| Customer visit to a | High | 45 |
| store and time | | |
| spent in the store | | |
| Frequency of | Medium | 20 |
| customer's visit to | | |
| a store | | |
| Total purchases | Low | 5 |
| made by the | | |
| customer | | |
| Trend of purchase | Medium | 20 |
| Satisfaction | High | 45 |

Based on the predefined rating values shown in the Table 3, the customer score for customer “A” is calculated using the Equation 2.

By substituting the predefined rating values from Table 3 in the Equation 2, the customer score is computed.

Similarly, the item score and the heterogeneity score are also calculated, with respect to each of the one or more customers.

The item score is calculated based on one or more predefined item parameters, associated with the item data. The one or more predefined item parameters may include, but not limited to, when the item entered the market, the item sold in the market, frequency of the item sold on a monthly basis, frequency of the item sold in the areas and items sold without promotions, as shown in the below Table 4.

TABLE 4

| | Content of the | |
|---|---|---|
| Item parameters | item parameters | Categories |
| When the item entered | Once a month | Low |
| the market | Once a week | Medium |
| | Daily | High |
| Item sold in the | Once a month | Low |
| market | Once a week | Medium |
| | Daily | High |
| | Never | Not applicable |
| Frequency of item sold | More than 100 | High |
| on a monthly basis | Between 50-100 | Medium |
| | Less than 50 | Low |
| Frequency of item sold | In all geographies | High |
| in the areas | In limited geographies | Medium |
| | Only in 1 store | Low |
| Items sold without | Never sold | Low |
| promotions | 1 or 2 items sold | Medium |
| | More than 5 items sold | High |

Each of the low category, the medium category and the high category is associated with the predefined weightage and the predefined impact value as shown in Table 2. The predefined rating value is calculated using the Equation 1.

Based on the predefined rating values, the item score for each of the one or more customers is calculated using the Equation 3.

The heterogeneity score is calculated based on one or more predefined heterogeneity parameters. The one or more predefined heterogeneity parameters may include, but not limited to, average age of the one or more customers purchasing the item, type of purchase, value of purchase, location of the customer who purchased the item and purchase made using the promo codes or coupons, as shown in Table 5.

TABLE 5

| Heterogeneity | Content of the heterogeneity | |
|---|---|---|
| parameters | parameters | Factors |
| Average age of the | More than 50 years | Low |
| one or more customers | Between 25 to 50 years | Medium |
| purchasing the item | Less than 25 years | High |
| Type of purchase | Just 1 item picked | Low |
| | Intentional purchase | Medium |
| | Emotional purchase | High |
| | Nothing purchased | Not |
| | | applicable |
| Value of Purchase | Very high value (100 or more) | High |
| | Between 50 to 100 | Medium |
| | Less than 50 | Low |
| Location of the | All geographies | High |
| customer who | Limited geographies | Medium |
| purchased the item | Only 1 store | Low |
| Purchase using coupons | Only the promo items bought | Low |
| or promo code | Promo item and its related items | Medium |
| | Greater than 5 products | High |
| | including the promo item | |

Each of the low category, the medium category and the high category is associated with the predefined weightage and the predefined impact value as shown in Table 2. The predefined rating value is calculated using the Equation 1.

Based on the predefined rating values, the heterogeneity score for each of the one or more customers is calculated using the Equation 4.

In an embodiment, the determining module 225, determines the opportunity value for each of the one or more end users. The opportunity value indicates the opportunity available to achieve a predefined target with respect to each of the one or more end users.

The opportunity value may determine how much revenue can be generated from the one or more customers, if more promotions are provided to the one or more customers. The fourth predefined technique as shown in the Equation 5 may be used to calculate the opportunity value for each of the one or more customers.

As an example, the Table 6 below indicates the opportunity value determined for six customers namely “customer 1”, customer 2”, “customer 3”, “customer 4”, “customer 5” and “customer 6”.

TABLE 6

| | Item | Heterogeneity | Customer | Opportunity |
|---|---|---|---|---|
| | Score | Score | Score | value |
| Customer 1 | 30 | 12 | 19 | 18.95 |
| Customer 2 | 25 | 22 | 45 | 12.22 |
| Customer 3 | 19 | 20 | 19 | 20.00 |
| Customer 4 | 20 | 15 | 45 | 6.67 |
| Customer 5 | 25 | 45 | 19 | 59.21 |
| Customer 6 | 10 | 19 | 45 | 4.22 |

The opportunity value less than 5 indicates that the customer is potential but not buying sufficient number of items.

The opportunity value greater than 5 and less than 15 indicates that the customer is buying items but not happy with the items.

The opportunity value greater than 15 indicates that the customer is a promising customer and more promotions need to be provided to the customer.

As an example, in the above Table 6, the opportunity value of “customer 1” is 18.95. Since the opportunity value is greater than 15, “customer 1” is considered as a promising customer and more promotions may be provided to the “customer 1”.

In an embodiment, the determining module 225 further determines the revenue generation value for each of the one or more end users. The revenue generation value indicates revenue being generated with respect to each of the one or more end users. The revenue generation value may determine whether the revenue generated by the promotion of a specified item in the market has reached the pre-set benchmark or not. The revenue generation value also identifies if the promotion can add more value to the revenue generation.

The fifth predefined technique as shown in Equation 6 may be used to calculate the revenue generation value for each of the one or more customers.

As an example, the Table 7 below indicates the revenue generation value determined for six customers namely “customer 1”, customer 2”, “customer 3”, “customer 4”, “customer 5” and “customer 6”.

TABLE 7

| | Item | Customer | Base | Revenue |
|---|---|---|---|---|
| | Score | Score | value | Generation value |
| Customer 1 | 30 | 19 | $100.00 | 5.7 |
| Customer 2 | 25 | 45 | $100.00 | 11.25 |
| Customer 3 | 19 | 19 | $100.00 | 3.61 |
| Customer 4 | 20 | 45 | $100.00 | 9 |
| Customer 5 | 25 | 19 | $100.00 | 4.75 |
| Customer 6 | 10 | 45 | $100.00 | 4.5 |

The revenue generation value less than 5 indicates that the target is not achieved well. The revenue generation value greater than 5 and less than 10 indicates that the target of revenue generation is moderately achieved. The revenue generation value greater than 10 indicates that the target is achieved for the customer.

As an example, in the above Table 7, the revenue generation value of “customer 1” is 5.7. The revenue generation value is greater than 5 and less than 10, indicating that the target of revenue generation for the “customer 1” was moderately achieved.

In an embodiment, the determination module 225 further determines the effectiveness result based on the opportunity value and the revenue generation value. The effectiveness result indicates the effectiveness of marketing. The effectiveness result is a value calculated for each of the one or more end users, to evaluate the success of marketing with respect to each of the one or more end users, instead of an overall general result. The effectiveness result helps in targeting the end users better in the subsequent marketing.

The effectiveness result may determine the success or failure of a promotion/marketing for items in the market.

A sixth predefined technique as shown in the Equation 7 is used to calculate the effectiveness result for each of the one or more customers.

As an example, the Table 8 below indicates the effectiveness result determined for six customers namely “customer 1”, customer 2”, “customer 3”, “customer 4”, “customer 5” and “customer 6”.

TABLE 8

| | Opportunity | Revenue | Effectiveness |
|---|---|---|---|
| | value | Generation value | Result |
| Customer 1 | 18.9 | 5.7 | 1.6 |
| Customer 2 | 12.2 | 11.25 | 3.0 |
| Customer 3 | 20.0 | 3.61 | 1.4 |
| Customer 4 | 6.7 | 9 | 4.2 |
| Customer 5 | 59.2 | 4.75 | 1.2 |
| Customer 6 | 4.2 | 4.5 | 3.8 |

The effectiveness result less than 2 indicates that the promotion did not succeed.

The effectiveness result between 2 to 4 indicates that the promotion was moderately successful.

The effectiveness result greater than 4 indicates that the promotion was a total success.

As an example, in the above Table 8, the effectiveness result of “Customer 1” is 1.6. The effectiveness result is less than 2, indicating that the promotion did not succeed with respect to customer 1.

FIG. 3 illustrates a flowchart for determining effectiveness in marketing, in accordance with some embodiments of the present disclosure.

As illustrated in FIG. 3, the method 300 comprises one or more blocks illustrating a method for determining effectiveness in marketing. The method 300 may be described in the general context of computer executable instructions. Generally, computer executable instructions can include routines, programs, objects, components, data structures, procedures, modules, and functions, which perform particular functions or implement particular abstract data types.

The order in which the method 300 is described is not intended to be construed as a limitation, and any number of the described method blocks can be combined in any order to implement the method. Additionally, individual blocks may be deleted from the methods without departing from the spirit and scope of the subject matter described herein. Furthermore, the method can be implemented in any suitable hardware, software, firmware, or combination thereof.

At block 301, marketing data 104 is received from one or more data sources 103 by an evaluation device 107 for determining effectiveness in marketing. In an embodiment, the marketing data 104 is received by a user interface 111 configured in the evaluation device 107. As an example, the one or more data sources 103 may include, but not limited to, an entity management systems like item management system, an end user database system like customer data base system, an end user log such as visitors log, time in and time out logs etc.

At block 303, one or more scores are determined for each of one or more end users based on the marketing data 104. In an embodiment, the processor 109 determines one or more scores with respect to each of the one or more end users. The one or more scores may be, a first score related to the one or more end users, a second score related to entities and a third score related to factors associated with the one or more end users and the entities. The first score may be referred as a customer score, the second score may be referred as an item score and the third score may be referred as a heterogeneity score. The customer score is related to the one or more customers of the goods and service, the item score is related to the items for marketing and the heterogeneity score is related to the factors associated with the one or more customers and the items.

The first score is calculated based on one or more predefined first parameters, associated with the one or more end users. The second score is calculated based on one or more predefined second parameters, associated with the entities. The third score is calculated based on one or more predefined third parameters, associated with the factors associated with the one or more end users and the entities. Consider the aforementioned example of marketing of goods and services. The one or more predefined first parameters are referred to as customer parameters. The customer parameters may include, but not limited to, customer visit to a store and time spent in the store, frequency of customer's visit to the store, total purchases made by the customer, trend of purchase of the customer and satisfaction level of a customer. The one or more predefined second parameters are referred to as item parameters. The item parameters may include, but not limited to, when the item entered the market, the item sold in the market, frequency of the item sold on a monthly basis, frequency of the item sold in the areas and items sold without promotions. The one or more predefined third parameters are referred to as heterogeneity parameters. The heterogeneity parameters may include, but not limited to, average age of the one or more customers purchasing the item, type of purchase, value of purchase, location of the customer who purchased the item and purchase made using the promo codes or coupons.

At block 305, an opportunity value is determined by the evaluation device 107 for each of the one or more end users. In an embodiment, the processor 109 uses the determined each of the one or more scores to determine an opportunity value with respect to each of the one or more end users. The opportunity value indicates the opportunity available to achieve a predefined target with respect to each of the one or more end users.

At block 307, a revenue generation value is determined by the evaluation device 107 for each of the one or more end users. In an embodiment, the processor 109 determines a revenue generation value using the determined one or more scores with respect to each of the one or more end users. The revenue generation value indicates revenue being generated with respect to each of the one or more end users.

At block 309, an effectiveness result is determined by the evaluation device 107. In an embodiment, the opportunity value and the revenue generation value determined are correlated using a sixth predefined technique as shown in Equation 7, to obtain an effectiveness result. The effectiveness result indicates the effectiveness achieved in the marketing. The effectiveness result is a value calculated for each of the one or more end users, to evaluate the success of marketing with respect to each of the one or more end users, instead of an overall general result. The effectiveness result helps in targeting the end users better in the subsequent marketing.

FIG. 4 is a block diagram of an exemplary computer system for implementing embodiments consistent with the present disclosure.

In an embodiment, the evaluation device 400 is used for determining effectiveness in marketing. The evaluation device 400 may comprise a central processing unit (“CPU” or “processor”) 402. The processor 402 may comprise at least one data processor for executing program components for executing user- or system-generated business processes. A user may include a person, a person using a device such as such as those included in this invention, or such a device itself. The processor 402 may include specialized processing units such as integrated system (bus) controllers, memory management control units, floating point units, graphics processing units, digital signal processing units, etc.

The processor 402 may be disposed in communication with one or more input/output (I/O) devices (411 and 412) via 1/O interface 401. The I/O interface 401 may employ communication protocols/methods such as, without limitation, audio, analog, digital, stereo, IEEE-1394, serial bus, Universal Serial Bus (USB), infrared, PS/2, BNC, coaxial, component, composite, Digital Visual Interface (DVI), high-definition multimedia interface (HDMI), Radio Frequency (RF) antennas, S-Video, Video Graphics Array (VGA), IEEE 802.n/b/g/n/x, Bluetooth, cellular (e.g., Code-Division Multiple Access (CDMA), High-Speed Packet Access (HSPA+), Global System For Mobile Communications (OSM), Long-Term Evolution (LTE), WiMax, or the like), etc.

Using the I/O interface 401, the evaluation device 400 may communicate with one or more I/O devices (411 and 412).

In some embodiments, the processor 402 may be disposed in communication with a communication network 409 via a network interface 403. The network interface 403 may communicate with the communication network 409. The network interface 403 may employ connection protocols including, without limitation, direct connect, Ethernet (e.g., twisted pair 10/100/1000 Base T), Transmission Control Protocol/Internet Protocol (TCP/IP), token ring, IEEE 802.11a/b/g/n/x, etc. Using the network interface 403 and the communication network 409, the evaluation device 400 may communicate with one or more data sources 410 (a, . . . ,n). The communication network 409 can be implemented as one of the different types of networks, such as intranet or Local Area Network (LAN) and such within the organization. The communication network 409 may either be a dedicated network or a shared network, which represents an association of the different types of networks that use a variety of protocols, for example, Hypertext Transfer Protocol (HTTP), Transmission Control Protocol/Internet Protocol (TCP/IP), Wireless Application Protocol (WAP), etc., to communicate with each other. Further, the communication network 409 may include a variety of network devices, including routers, bridges, servers, computing devices, storage devices, etc. The one or more data sources 410 (a, . . . ,n) may include, without limitation, personal computer(s), mobile devices such as cellular telephones, smartphones, tablet computers, eBook readers, laptop computers, notebooks, gaming consoles, or the like.

In some embodiments, the processor 402 may be disposed in communication with a memory 405 (e.g., RAM, ROM, etc. not shown in FIG. 4) via a storage interface 404. The storage interface 404 may connect to memory 405 including, without limitation, memory drives, removable disc drives, etc., employing connection protocols such as Serial Advanced Technology Attachment (SATA), Integrated Drive Electronics (IDE), IEEE-1394, Universal Serial Bus (USB), fiber channel, Small Computer Systems Interface (SCSI), etc. The memory drives may further include a drum, magnetic disc drive, magneto-optical drive, optical drive, Redundant Array of Independent Discs (RAID), solid-state memory devices, solid-state drives, etc.

The memory 405 may store a collection of program or database components, including, without limitation, user interface application 406, an operating system 407, web server 408 etc. In some embodiments, evaluation device 400 may store user/application data 406, such as the data, variables, records, etc. as described in this invention. Such databases may be implemented as fault-tolerant, relational, scalable, secure databases such as Oracle or Sybase.

The operating system 407 may facilitate resource management and operation of the evaluation device 400. Examples of operating systems include, without limitation, Apple Macintosh OS X, UNIX, Unix-like system distributions (e.g., Berkeley Software Distribution (BSD), FreeBSD, NetBSD, OpenBSD, etc.), Linux distributions (e.g., Red Hat, Ubuntu, Kubuntu, etc.), International Business Machines (IBM) OS/2, Microsoft Windows (XP, Vista/7/8, etc.), Apple iOS, Google Android, Blackberry Operating System (OS), or the like. User interface 406 may facilitate display, execution, interaction, manipulation, or operation of program components through textual or graphical facilities. For example, user interfaces may provide computer interaction interface elements on a display system operatively connected to the evaluation device 400, such as cursors, icons, check boxes, menus, scrollers, windows, widgets, etc. Graphical User Interfaces (GUIs) may be employed, including, without limitation, Apple Macintosh operating systems' Aqua, IBM OS/2, Microsoft Windows (e.g., Aero, Metro, etc.), Unix X-Windows, web interface libraries (e.g., ActiveX, Java, Javascript, AJAX, HTML, Adobe Flash, etc.), or the like.

In some embodiments, the evaluation device 400 may implement a web browser 408 stored program component. The web browser may be a hypertext viewing application, such as Microsoft Internet Explorer, Google Chrome, Mozilla Firefox, Apple Safari, etc. Secure web browsing may be provided using Secure Hypertext Transport Protocol (HTTPS) secure sockets layer (SSL), Transport Layer Security (TLS), etc. Web browsers may utilize facilities such as AJAX, DHTML, Adobe Flash, JavaScript, Java, Application Programming Interfaces (APIs), etc. In some embodiments, the evaluation device 400 may implement a mail server stored program component. The mail server may be an Internet mail server such as Microsoft Exchange, or the like. The mail server may utilize facilities such as Active Server Pages (ASP), ActiveX, American National Standards Institute (ANSI)C++/C#, Microsoft .NET, CGI scripts, Java, JavaScript, PERL, PHP, Python, WebObjects, etc. The mail server may utilize communication protocols such as Internet Message Access Protocol (IMAP), Messaging Application Programming Interface (MAPI), Microsoft Exchange, Post Office Protocol (POP), Simple Mail Transfer Protocol (SMTP), or the like. In some embodiments, the evaluation device 400 may implement a mail client stored program component. The mail client may be a mail viewing application, such as Apple Mail, Microsoft Entourage, Microsoft Outlook, Mozilla Thunderbird, etc.

Furthermore, one or more computer-readable storage media may be utilized in implementing embodiments consistent with the present invention. A computer-readable storage medium refers to any type of physical memory on which information or data readable by a processor may be stored. Thus, a computer-readable storage medium may store instructions for execution by one or more processors, including instructions for causing the processor(s) to perform steps or stages consistent with the embodiments described herein. The term “computer-readable medium” should be understood to include tangible items and exclude carrier waves and transient signals, i.e., non-transitory. Examples include Random Access Memory (RAM), Read-Only Memory (ROM), volatile memory, non-volatile memory, hard drives, Compact Disc (CD) ROMs, Digital Video Disc (DVDs), flash drives, disks, and any other known physical storage media.

### Advantages of the Embodiment of the Present Disclosure are Illustrated Herein

In an embodiment, the present disclosure provides a method for determining effectiveness in marketing.

In the marketing of goods and services, the present disclosure provides a feature wherein the items that need promotion can be identified and competitive advantage of a brand over other brands can be identified. This helps in targeting the correct items that require marketing.

The present disclosure provides a feature wherein the analysis is performed with respect to each end user in the marketing, instead of performing an overall analysis.

A description of an embodiment with several components in communication with each other does not imply that all such components are required. On the contrary a variety of optional components are described to illustrate the wide variety of possible embodiments of the invention.

When a single device or article is described herein, it will be readily apparent that more than one device/article (whether or not they cooperate) may be used in place of a single device/article. Similarly, where more than one device or article is described herein (whether or not they cooperate), it will be readily apparent that a single device/article may be used in place of the more than one device or article or a different number of devices/articles may be used instead of the shown number of devices or programs. The functionality and/or the features of a device may be alternatively embodied by one or more other devices which are not explicitly described as having such functionality/features. Thus, other embodiments of the invention need not include the device itself.

The specification has described a method and a device for determining effectiveness in marketing. The illustrated steps are set out to explain the exemplary embodiments shown, and it should be anticipated that on-going technological development will change the manner in which particular functions are performed. These examples are presented herein for purposes of illustration, and not limitation. Further, the boundaries of the functional building blocks have been arbitrarily defined herein for the convenience of the description. Alternative boundaries can be defined so long as the specified functions and relationships thereof are appropriately performed. Alternatives (including equivalents, extensions, variations, deviations, etc., of those described herein) will be apparent to persons skilled in the relevant art(s) based on the teachings contained herein. Such alternatives fall within the scope and spirit of the disclosed embodiments. Also, the words “comprising,” “having,” “containing,” and “including,” and other similar forms are intended to be equivalent in meaning and be open ended in that an item or items following any one of these words is not meant to be an exhaustive listing of such item or items, or meant to be limited to only the listed item or items. It must also be noted that as used herein and in the appended claims, the singular forms “a,” “an,” and “the” include plural references unless the context clearly dictates otherwise.

Finally, the language used in the specification has been principally selected for readability and instructional purposes, and it may not have been selected to delineate or circumscribe the inventive subject matter. It is therefore intended that the scope of the invention be limited not by this detailed description, but rather by any claims that issue on an application based here on. Accordingly, the embodiments of the present invention are intended to be illustrative, but not limiting, of the scope of the invention, which is set forth in the following claims.

### REFERRAL NUMERALS

| Reference Number | Description |
|---|---|
| 100 | Architecture |
| 103 | One or more data sources |
| 104 | Marketing data |
| 105 | Communication network |
| 107 | Evaluation device |
| 109 | Processor |
| 111 | User interface |
| 113 | Memory |
| 203 | Data |
| 205 | Modules |
| 209 | Score Data |
| 213 | Opportunity value data |
| 215 | Revenue generation value data |
| 217 | Effectiveness result data |
| 219 | Other data |
| 221 | Receiving module |
| 225 | Determining module |
| 229 | Other modules |

What is claimed is:

1. A method for determining effectiveness in marketing, the method comprising:
receiving, by an evaluation device, marketing data from one or more data sources;
determining, by the evaluation device, one or more scores based on the marketing data, wherein the one or more scores comprises a first score related to one or more end users, a second score related to entities and a third score related to factors associated with the one or more end users and the entities;
determining, by the evaluation device, an opportunity value for each of one or more end users based on the determined each of the one or more scores, wherein the opportunity value indicates opportunity available for achieving a predefined target corresponding to each of the one or more end users;
determining, by the evaluation device, a revenue generation value for each of the one or more end users based on the determined each of the one or more scores, wherein the revenue generation value indicates revenue being generated, corresponding to each of the one or more end users, based on the marketing; and
determining, by the evaluation device, an effectiveness result based on the opportunity value and the revenue generation value, wherein the effectiveness result indicates the effectiveness in the marketing.

2. The method as claimed in claim 1, wherein determining the first score comprises:
classifying, by the evaluation device, one or more predefined first parameters associated with the one or more end users into one of a low category, a medium category and a high category;
assigning, by the evaluation device, a predefined rating value to the low category, the medium category, and the high category, based on predefined weightage and predefined impact value corresponding to each of the low category, the medium category and the high category; and
determining, by the evaluation device, the first score, based on the predefined rating value.

3. The method as claimed in claim 1, wherein determining the second score comprises:
classifying, by the evaluation device, one or more predefined second parameters associated with the entities, into one of the low category, the medium category and the high category;
assigning, by the evaluation device, the predefined rating value to the low category, medium category and the high category, based on the predefined weightage and the predefined impact value corresponding to each of the low category, the medium category and the high category; and
determining, by the evaluation device, the second score, based on the predefined rating value.

4. The method as claimed in claim 1, wherein determining the third score comprises:
classifying, by the evaluation device, one or more predefined third parameters associated with the one or more end users and entities, into one of the low category, the medium category and the high category;
assigning, by the evaluation device, the predefined rating value to the low category, the medium category and the high category based on the predefined weightage and the predefined impact value corresponding to each of the low category, the medium category and the high category; and
determining, by the evaluation device, the third score, based on the predefined rating value.

5. An evaluation device for determining effectiveness in marketing, the evaluation device comprising:
a processor, and a memory communicatively coupled to the processor, wherein the memory stores the processor-executable instructions, which, on execution, causes the processor to:
receive marketing data from one or more data sources;
determine one or more scores based on the marketing data, wherein the one or more scores comprises a first score related to one or more end users, a second score related to entities and a third score related to factors associated with the one or more end users and the entities;
determine an opportunity value for each of one or more end users based on the determined each of the one or more scores, wherein the opportunity value indicates opportunity available for achieving a predefined target corresponding to each of the one or more end users;
determine a revenue generation value for each of the one or more end users based on the determined each of the one or more scores, wherein the revenue generation value indicates revenue being generated, corresponding to each of the one or more end users, based on the marketing; and
determine an effectiveness result based on the opportunity value and the revenue generation value, wherein the effectiveness result indicates the effectiveness in the marketing.

6. The evaluation device as claimed in claim 5, wherein the processor determines the first score by:
classifying one or more predefined first parameters associated with the one or more end users into one of a low category, a medium category and a high category;
assigning, a predefined rating value to the low category, the medium category, and the high category, based on predefined weightage and predefined impact value corresponding to each of the low category, the medium category and the high category; and
determining, the first score, based on the predefined rating value.

7. The evaluation device as claimed in claim 5, wherein the processor determines the second score by:
classifying, one or more predefined second parameters associated with the entities, into one of the low category, the medium category and the high category;
assigning, the predefined rating value to the low category, the medium category and the high category, based on the predefined weightage and the predefined impact value corresponding to each of the low category, the medium category and the high category; and
determining, the second score based on the predefined rating value.

8. The evaluation device as claimed in claim 5, wherein determining the third score comprises:
classifying, one or more predefined third parameters associated with the one or more end users and entities, into one of the low category, the medium category and the high category;
assigning, the predefined rating value to the low category, the medium category and the high category based on the predefined weightage and the predefined impact value corresponding to each of the low category, the medium category and the high category; and
determining, the third score based on the predefined rating value.

9. The evaluation device as claimed in claim 5, wherein the one or more data sources are at least one of an entity management systems, an end user database system, an end user log and video recording devices.

10. A non-transitory computer readable medium including instructions stored thereon that when processed by at least one processor causes an evaluation device to perform operations comprising:
receiving marketing data from one or more data sources;
determining one or more scores based on the marketing data, wherein the one or more scores comprises a first score related to one or more end users, a second score related to entities and a third score related to factors associated with the one or more end users and entities;
determining an opportunity value for each of one or more end users based on the determined each of the one or more scores, wherein the opportunity value indicates opportunity available for achieving a predefined target corresponding to each of the one or more end users;
determining a revenue generation value for each of the one or more end users based on the determined each of the one or more scores, wherein the revenue generation value indicates revenue being generated, corresponding to each of the one or more end users; and
determining an effectiveness result based on the opportunity value and the revenue generation value, wherein the effectiveness result indicates the effectiveness in the marketing.
